(19) United States
(12) Patent Application Publication
(10) Pub. No.: US 2005/0124380 A1
(43) Pub. Date: Jun. 9, 2005

(54) Method of controling a communications session

(76) Inventors: Daniel S. Rokusek, Long Grove, IL (US); Raghunandan Sanjeev, Palatine, IL (US)

Correspondence Address: MOTOROLA, INC., Corporate Law Department - #56-238, 3102 North 56th Street, Phoenix, AZ, 85018, US

(21) Appl. No.: 10/729,786

(22) Filed: Dec. 5, 2003

(51) Int. Cl. H04Q 7/20

(52) U.S. Cl. 455/556.1

(57) ABSTRACT

Method of controlling a communications session (101) can include a handset (102) determining one of a docked condition (150) and an undocked condition (152). A communications session (101) is initiated where the communications session spans from the handset (102) to a remote communications device (104) using a WPAN communications link (110), and out from the remote communications device (104) using a cellular link (112). The handset (102) can translate between the WPAN communications link (110) and the cellular link (112). If the handset (102) is in the docked condition (150), the handset (102) can route an audio component (153) through the docking station (106). If the handset (102) is in the undocked condition (152), the handset (102) can route the audio component (155) through the handset (102).

### BACKGROUND OF THE INVENTION

Cellular phones are increasingly becoming smaller and are not user-friendly when used in an automobile. New wireless technologies allow consumers to put their cellular phone aside while placing calls through wireless hands-free systems. However, consumers still have reason to desire privacy not afforded under the hands-free scenario.

In the prior art, a telematics unit mounted in a vehicle allows the use of a hand-held portion for privacy or a hands-free mode when the hand-held portion is in its cradle. In either mode, calls are channeled through an embedded cellular unit within the telematics unit. In the privacy mode with the hand-held portion in use, the hand-held portion merely routes the call, via a short range wireless signal, through the cellular unit embedded within telematics unit. In the hands-free mode, the hand-held portion is in its cradle and the call is routed entirely though the embedded cellular unit within the telematics unit, with the hand-held portion not serving any function. The prior art has several disadvantages. First, this configuration has multiple components leading to greater cost and wiring to multiple distributed components. Also, the handheld portion is utilized only with the telematics unit mounted in the vehicle and not with portable cellular phones brought into the vehicle.

Accordingly, there is a significant need for a method and apparatus that overcomes the deficiencies of the prior art outlined above.

### BRIEF DESCRIPTION OF THE DRAWINGS

Referring to the drawing:

FIG. 1 depicts a communications system according to one embodiment of the invention; and

FIG. 2 illustrates a flow diagram of a method of the invention according an embodiment of the invention.

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENTS

In the following detailed description of exemplary embodiments of the invention, reference is made to the accompanying drawings, which illustrate specific exemplary embodiments in which the invention may be practiced. These embodiments are described in sufficient detail to enable those skilled in the art to practice the invention, but other embodiments may be utilized and logical, mechanical, electrical and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures, software blocks and techniques have not been shown in detail in order not to obscure the invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact. However, “coupled” may also mean that two or more elements are not in direct contact with each other, but yet still co-operate or interact with each other.

For clarity of explanation, the Figures illustrate embodiments of the present invention, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

The following embodiments can include software blocks that can be computer program modules comprising computer instructions that are stored in a computer-readable medium such as a memory. These software modules are merely representative of one embodiment of the invention. In other embodiments, additional modules could be provided as needed, and/or unneeded modules could be deleted.

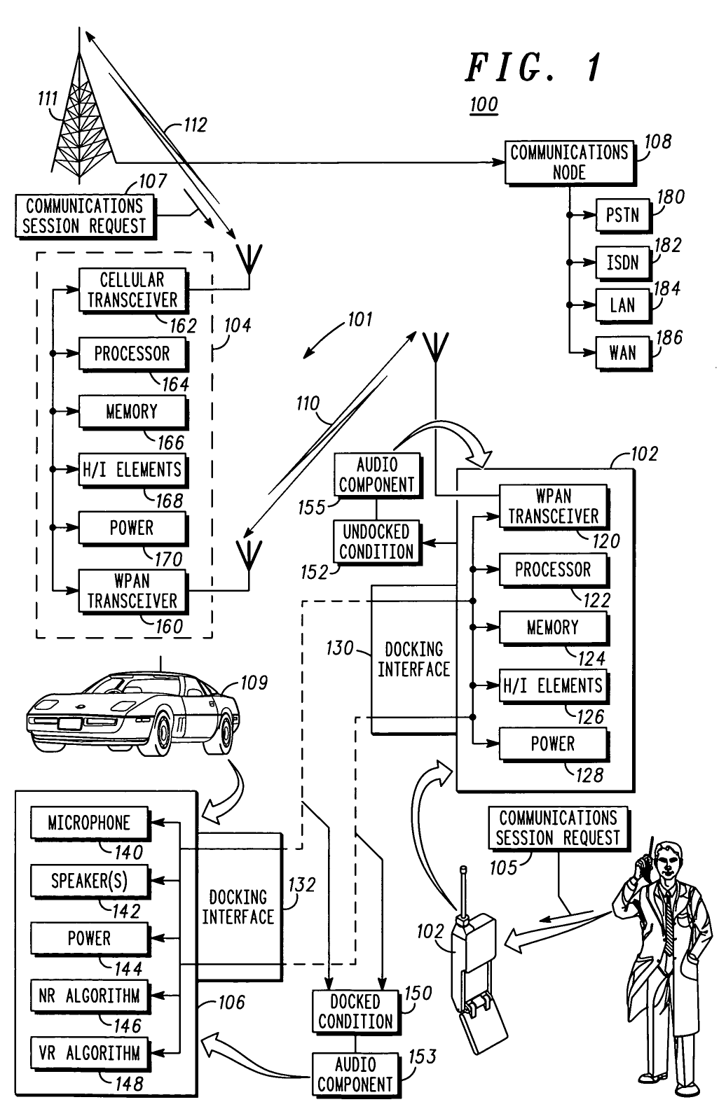

FIG. 1 depicts a communications system 100 according to one embodiment of the invention. As shown in FIG. 1, communications system 100 can include remote communications device 104, handset 102 coupled to interface with a docking station 106, and communications node 108.

Remote communications device 104 can include, without limitation, a wireless unit such as a cellular or Personal Communication System (PCS) telephone, a pager, a hand-held computing device such as a personal digital assistant (PDA) or Web appliance, a personal computer, or any other type of wireless or wireline communications and/or computing device. Remote communications device 104 can include, but is not limited to, functional and operative hardware and software modules, input/output (I/O) elements, display, and the like. Remote communications device 104 can communicate with communications node 108, for example and without limitation, via cellular link 112.

Remote communications device 104 can include a cellular transceiver 162 designed to communicate with communications node 108 via cellular link 112 and base station 111 or a satellite. Cellular transceiver 3162 can be coupled to a processor 164 for processing algorithms stored in memory 166. Memory 166 can comprise control algorithms, and can include, but is not limited to, random access memory (RAM), read only memory (ROM), flash memory, electrically erasable programmable ROM (EEPROM), and the like. Memory 166 can contain stored instructions, tables, data, and the like, to be utilized by processor 164. Cellular transceiver 162 can also be coupled to human interface (H/I) elements 168 and a power source 170 such as a battery, power converter, and the like.

Human interface (H/I) elements 168 can comprise elements such as a display, a multi-position controller, one or more control knobs, one or more indicators such as bulbs or light emitting diodes (LEDs), one or more control buttons, one or more speakers, a microphone, and any other H/I elements required by remote communications device 104. The invention is not limited by the (H/I) elements described above. As those skilled in the art will appreciate, the (H/I) elements outlined above are meant to be representative and to not reflect all possible (H/I) elements that may be employed.

Remote communications device 104 can also include a wireless personal area network (WPAN) transceiver 160. WPAN transceiver 160 is designed to electronically couple electronic devices in close proximity to one another utilizing only wireless links via a WPAN communications protocol.

Communications system 100 can include communications node 108, which can be coupled to any number of base stations 111 to provide wireless communication to and from remote communications device 104 via cellular link 112. Communications node 108 can be coupled to base station 111 via wireline or wireless communication links. In an embodiment, communications node 108 also can communicate with a satellite.

Communications node 108 can include content servers and content databases, which can include a hard drive, floppy disk drive, optical drive, CD-ROM, RAM, ROM, EEPROM, or any other means of storing content, which can be utilized by remote communications device 104. Communications node 108 can also include a communications node (CN) wireless interface, which can comprise one or more network access devices (NAD's) that can utilize a wireless network protocol that can include, without limitation, narrowband and/or broadband connections with standard cellular network protocols such as Global System for Mobile Communications (GSM), Time Division Multiple Access (TDMA), Code Division Multiple Access (CDMA), and the like. In another embodiment, standard transmission control protocol/internet protocol (TCP/IP) can also be used. CN wireless interface can also send and receive content using standard paging networks, FM sub-carriers, satellite networks, and the like. Communications node 108 can be coupled to a public switched telecommunication network (PSTN) 180, an integrated services digital network (ISDN) 182, one or more wide area networks (WAN's) 186, one or more local area networks (LAN's) 184, and any number of other communications nodes.

Communications system 100 can include handset 102 coupled to interface with docking station 106. In an embodiment, docking station 106 can be included in, or be an integral part of vehicle 109. Vehicle 109 can include, without limitation, a car, truck, bus, train, aircraft, boat, and the like.

Docking station 106 can be coupled to vehicle 109 via a wireline link and/or a wireless link (not shown). Docking station 106 can include power source 144, which can be a self-contained power source or be coupled to vehicle so as to provide power to docking station and handset 102 when docked in docking station 106. In an embodiment, docking station 106 can include or be coupled to a microphone 140 and one or more speaker(s) 142. In embodiment, docking station 106 can include a voice recognition (VR) algorithm 148 coupled to initiate a communications session 101 when handset 102 is in docked condition 150 (docked in docking station 106) or in undocked condition 152. In an embodiment, docking station 106 can include noise reduction (NR) algorithm 146 coupled to execute when handset 102 is in docked condition 150. This can, for example, reduce background noise when a docked condition 150 exists and handset is being used in a hands-free model. Docking interface 132 is coupled to interface with docking interface 130 on handset 102 when handset 102 is in docked condition 150. In another embodiment (not shown for clarity), VR algorithm 148 and/or NR algorithm 146 can be located in handset 102 or distributed between handset 102 and docking station 106.

Handset 102 can include WPAN transceiver 120, which can be designed to electronically couple electronic devices in close proximity to one another utilizing only wireless links via a WPAN communications protocol. In an embodiment, WPAN communications protocol can be used with any number of WPAN communications links 110 to establish a peer-to-peer environment or in a piconet environment. As an example of an embodiment, WPAN communications link 110 is designed to electronically couple devices within ten meters of each other. In an embodiment, handset 102 can communicate with remote communications device 104 using WPAN communications link 110 via WPAN transceiver 120. In other words, WPAN transceiver 160 in remote communications device 104 and WPAN transceiver 120 in handset 102 allow remote communications device 104 and handset 102 to communicate using WPAN communications link 110 operating using a WPAN communications protocol.

WPAN communications link 110 operates using a WPAN communications protocol. There are numerous WPAN communications protocols, each with their own software protocols and protocol stacks to enable handset 102 and remote communications device 104 to communicate and exchange content, including, voice, data, content, and the like. Examples of these WPAN communications protocols include, but are not limited to, Bluetooth, Object Exchange Protocol (OBEX), HomeRF, 802.11, Wireless Area Protocol (WAP), Dedicated Short Range Communication (DSRC) system, and the like. In a preferred embodiment of the invention, Bluetooth communications protocol is utilized as the WPAN communications protocol to operate WPAN communications link 110. Implementation of the invention using the Bluetooth communications protocol is not limiting of the invention. The invention can be implemented using other WPAN communications protocols and be within the scope of the invention.

WPAN transceiver 120 in handset 102 can be coupled to a processor 122 for processing algorithms stored in memory 124. Memory 124 can comprise control algorithms, and can include, but is not limited to, random access memory (RAM), read only memory (ROM), flash memory, electrically erasable programmable ROM (EEPROM), and the like. Memory 124 can contain stored instructions, tables, data, and the like, to be utilized by processor 122. WPAN transceiver 120 can also be coupled to human interface (H/I) elements 126 and a power source 128 such as a battery, and the like.

Human interface (H/I) elements 126 can comprise elements such as a display, a multi-position controller, one or more control knobs, one or more indicators such as bulbs or light emitting diodes (LEDs), one or more control buttons, one or more speakers, a microphone, and any other H/I elements required by handset 102. The invention is not limited by the (H/I) elements described above. As those skilled in the art will appreciate, the (H/I) elements outlined above are meant to be representative and to not reflect all possible (H/I) elements that may be employed.

In an embodiment, when handset 102 is coupled to docking station 106, handset 102 can determine that a docked condition 150 exists. When handset 102 is uncoupled from docking station 106, handset 102 can determine that an undocked condition 152 exists. This can be done, for example, by handset 102 detecting electrical and/or mechanical contact with docking station 106.

In an embodiment, a communications session 101 can be initiated using handset 102. For example, a user can utilize handset 102 in a docked condition 150 or an undocked condition 152 and initiate a communication session request 105 (place a call for example), by using one or more human interface elements 126 on handset 102. Subsequently, a communications session 101 can be created where the communications session 101 spans from handset 102 to remote communications device 104 using WPAN communications link 110, out from remote communications device 104 using cellular link 112, and to another party or entity through communications node 108. In this embodiment, the communications session 101 takes place through remote communications device 104 and handset 102, with handset 102 controlling the communications session 101 and using remote communications device 104 as a bridge to access other devices outside of the range of a WPAN network. Handset 102 translates between WPAN communications link 110 and cellular link 112. In other words, handset 102 can operate to translate voice and/or data between a WPAN communications protocol and a cellular communications protocol for communications session 101. In this exemplary embodiment, with handset 102 in undocked condition 152, handset 102 can route an audio component 155 of communications session 101, for example voice data, and the like, through handset 102. Docking station 106 and elements within docking station 106 play no role in communications session 101 under this embodiment.

In another embodiment, a communications session 101 can include establishing a WPAN communications link 110 when handset 102 is in proximity of remote communications device 104 and not include voice communication. In this embodiment, communications session 101 can include handset 102 showing signal strength, giving SMS or voicemail indications, and the like. In an embodiment, communications session 101 can include any exchange of data or voice between handset 102 and remote communications device 104.

In another embodiment, a communications session 101 can be initiated via voice recognition algorithm 148 in docking station 106, while handset 102 is in docked condition 150 or an undocked condition 152. For example, a user can initiate communications session 101 by speaking through a microphone 140 in docking station 106, thereby initiating communication session request 105. Subsequently, communications session I01 can be created where the communications session 101 spans from handset 102 to remote communications device 104 using WPAN communications link 110, out from remote communications device 104 using cellular link 112, and to another party or entity through communications node 108. In this embodiment, the communications session 101 takes place through remote communications device 104 and handset 102, with handset 102 controlling the communications session 101 and using remote communications device 104 as a bridge to access other devices outside of the range of a WPAN network. Handset 102 translates between WPAN communications link 110 and cellular link 112. In other words, handset 102 can operate to translate voice and/or data between a WPAN communications protocol and a cellular communications protocol for communications session 101. In this exemplary embodiment, docking station 106 serves only to relay communication session request 105 to handset 102, with handset 102 controlling the initiation of communication session request 105. In this embodiment, with handset 102 in docked condition 150, handset 102 can route audio component 153 of communications session 101, for example voice data, and the like, through docking station 106, such that, for example, microphone 140 and one or more speaker(s) 142 can be used during communications session 101. Although in this embodiment, elements of docking station 106 can be used for audio component 153, communications session 101 is controlled by, and routed through handset 102. In another embodiment, VR algorithm 148 can be in handset 102, with communications session 101 initiated without use of docking station, by using VR algorithm 148 in handset 102.

In yet another embodiment, a communications session 101 can be initiated by handset 102 receiving communication session request 107 from remote communications device 104. This can be, for example and without limitation, an incoming call to remote communications device 104. Subsequently, a communications session 101 can be created where the communications session 101 spans from handset 102 to remote communications device 104 using WPAN communications link 110, out from remote communications device 104 using cellular link 112, and to another party or entity through communications node 108. In this embodiment, the communications session 101 takes place through remote communications device 104 and handset 102, with handset 102 controlling the communications session 101 and using remote communications device 104 as a bridge to access other devices outside of the range of a WPAN network. Handset 102 translates between WPAN communications link 110 and cellular link 112. In other words, handset 102 can operate to translate voice and/or data between a WPAN communications protocol and a cellular communications protocol for communications session 101. In this embodiment, handset 102 can be in either undocked condition 152 or docked condition 150. If in undocked condition 152, handset 102 can route audio component 155 through handset 102 as described above. If in docked condition 150, handset 102 can route audio component 153 through docking station 106 as described above.

In still another embodiment, during communications session 101, handset 102 can transition back and forth between docked condition 150 and undocked condition 152. During such transitions, communications session 101 is maintained as spanning from handset 102 to remote communications device 104 using WPAN communications link 110, out from remote communications device 104 using cellular link 112, and to another party or entity through communications node 108. In this embodiment, communications session 101 continues to take place through remote communications device 104 and handset 102, with handset 102 controlling the communications session 101 and using remote communications device 104 as a bridge to access other devices outside of the range of a WPAN network. In other words, during a communications session 101 initiated by any means, a constant wireless connection using WPAN communications link 110 and cellular link 112 is maintained as described above.

The configuration, including the type and number of devices depicted in FIG. 1 are exemplary and not meant to be limiting of the invention. Other electronic devices can be included and other configurations are possible and within the scope of the invention.

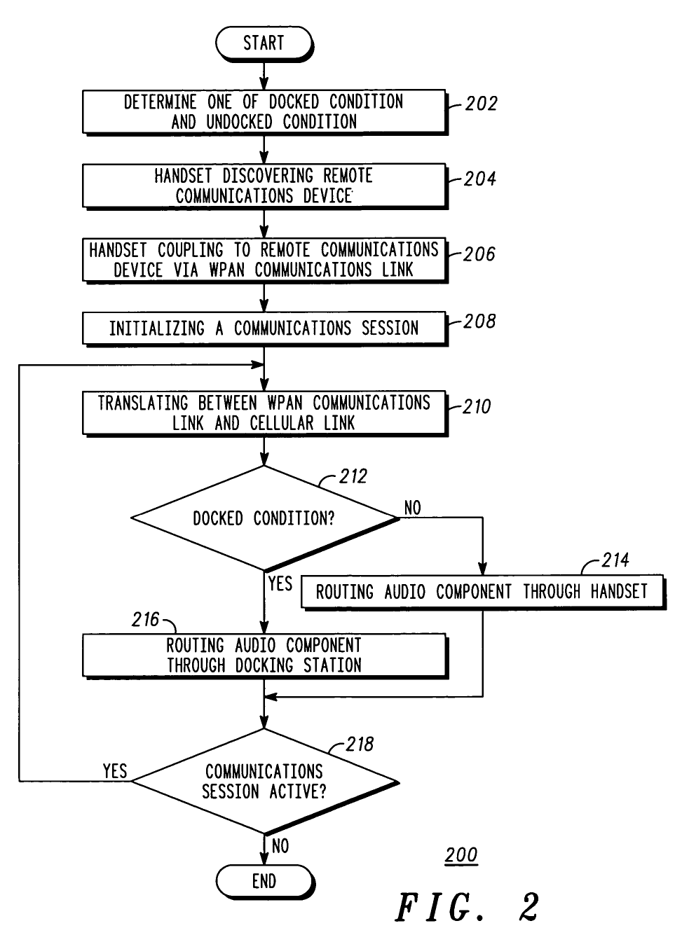

FIG. 2 illustrates a flow diagram of a method of the invention according an embodiment of the invention. In step 202, upon powering up, handset determines if either a docked condition or an undocked condition exists. This can be done, for example, by handset detecting electrical and/or mechanical contact with docking station. In step 204, handset can go in a discovery mode where handset can detect other devices, for example, remote communications device, within range of a WPAN communications link. In step 206, if handset detects, for example, remote communications device, handset can couple with remote communications device via WPAN communications link.

In step 206, a communications session can be initiated by a communication session request as described in any of the embodiments above. Communications session can be created where the communications session spans from handset to remote communications device using WPAN communications link, out from remote communications device using cellular link, and to another party or entity through a communications node. In this embodiment, the communications session takes place through remote communications device and handset, with handset controlling the communications session and using remote communications device as a bridge to access other devices outside of the range of a WPAN network. In step 208, during and subsequent to establishment of communications session, handset can translate between WPAN communications link and cellular link.

In step 212, it is determined if docked condition exists. In other words, it is determined if handset is docked with docking station. If not, handset routes an audio component of communications session through handset per step 214. If so, handset routes an audio component of communications session through docking station per step 216. In step 218, it is determined if communications session is still active. If so, handset continues to translate per step 210, as indicated by the return arrow. Also, routing of audio component can change per steps 212, 214 and 216 as long as communications system is active. If communications session is no longer active per step 218, communications session is terminated.

While we have shown and described specific embodiments of the present invention, further modifications and improvements will occur to those skilled in the art. It is therefore, to be understood that appended claims are intended to cover all such modifications and changes as fall within the true spirit and scope of the invention.

1. A method, comprising:
providing a handset coupled to interface with a docking station;
the handset determining one of a docked condition and an undocked condition;
initiating a communications session, wherein the communications session spans from the handset to a remote communications device using a WPAN communications link, and out from the remote communications device using a cellular link;
the handset translating between the WPAN communications link and the cellular link;
if the handset is in the docked condition, the handset routing an audio component through the docking station; and
if the handset is in the undocked condition, the handset routing the audio component through the handset.

2. The method of claim 1, wherein the WPAN communications link utilizes a Bluetooth communications protocol.

3. The method of claim 1, further comprising the handset discovering and coupling to the remote communications device using the WPAN communications link.

4. The method of claim 1, wherein the docking station is integrated with a vehicle.

5. The method of claim 1, further comprising if the handset is in the docked condition, initiating the communications session via voice recognition algorithm in one of the docking station and the handset.

6. The method of claim 1, further comprising if the handset is in the docked condition, one of the docking station and the handset executing a noise reduction algorithm during the communications session.

7. The method of claim 1, further comprising initiating the communications session using a human interface element on the handset.

8. The method of claim 1, wherein initiating the communications session comprises initiating the communications session using the handset.

9. The method of claim 1, wherein initiating the communications session comprises the handset receiving a communication session request from the remote communications device.

10. A handset coupled to interface with a docking station, comprising a computer-readable medium containing computer instructions for instructing a processor to perform a method of controlling a communications session, the instructions comprising:
the handset determining one of a docked condition and an undocked condition;
initiating the communications session, wherein the communications session spans from the handset to a remote communications device using a WPAN communications link, and out from the remote communications device using a cellular link;
the handset translating between the WPAN communications link and the cellular link;
if the handset is in the docked condition, the handset routing an audio component through the docking station; and
if the handset is in the undocked condition, the handset routing the audio component through the handset.

11. The handset of claim 10, wherein the WPAN communications link utilizes a Bluetooth communications protocol.

12. The handset of claim 10, further comprising the handset discovering and coupling to the remote communications device using the WPAN communications link.

13. The handset of claim 10, wherein the docking station is integrated with a vehicle.

14. The handset of claim 10, further comprising if the handset is in the docked condition, initiating the communications session via voice recognition algorithm in one of the docking station and the handset.

15. The handset of claim 10, further comprising if the handset is in the docked condition, one of the docking station and the handset executing a noise reduction algorithm during the communications session.

16. The handset of claim 10, further comprising initiating the communications session using a human interface element on the handset.

17. The handset of claim 10, wherein initiating the communications session comprises initiating the communications session using the handset.

18. The handset of claim 10, wherein initiating the communications session comprises the handset receiving a communication session request from the remote communications device.
